(19) United States
(12) Patent Application Publication
(10) Pub. No.: US 2023/0404118 A1
(43) Pub. Date: Dec. 21, 2023

(54) INSTANT RICE AND A PREPARATION PROCESS THEREOF

(71) Applicant: Hangzhou Yu, Lianyungang (CN)

(72) Inventor: Hangzhou Yu, Lianyungang (CN)

(21) Appl. No.: 17/847,013

(22) Filed: Jun. 22, 2022

(30) Foreign Application Priority Data
May 24, 2022 (CN) 202210573090.8

(51) Int. Cl. A23L 7/143; A23C 9/15; A23L 7/196; A23L 19/15; A23L 7/122; A23L 5/10

(52) U.S. Cl. CPC A23L 7/143; A23C 9/1508; A23L 5/11; A23L 19/15; A23L 7/122; A23L 7/196

(57) ABSTRACT

The invention relates to instant rice and a preparation process thereof. The components comprise sticky-free glutinous rice, milk powder, multigrain powder, fruit and vegetable powder, nut powder. The preparation process comprises following steps: 1) making sticky-free glutinous rice; 2) adding auxiliary materials; 3) packaging. The invention has the following advantages: simple components, convenient preparation, convenience, feeling full, nutrition, delicious taste and other advantages, and is more suitable for large-scale centralized production, and has a high hygienic index, the industrial standards of its production can be customized to avoid the disadvantages of poor hygienic conditions in snack bars that fail to meet hygienic requirements, it is suitable for single packaging, transportation and long-term storage, and is conducive to the rapid development of the food culture and customs of powder food brewing. It has a wide range of application scenarios, high market commercial value, and benefits the country and people.

### 1. TECHNICAL FIELD

The invention relates to the technical field of food processing, in particular to instant rice and a preparation process thereof.

### 2. BACKGROUND ART

Glutinous rice is warm in nature and sweet in taste, it is conducive to the treatment of lung and spleen diseases and has the effect of tonifying deficiency and blood, strengthening spleen and warming stomach. Glutinous rice is also rich in nutrients such as protein, calcium, phosphorus, iron, and Nicotinic acid, which can be regarded as a warming and healthy food.

With the development of society, the acceleration of people's pace of life and the improvement of the quality of life, people's requirements for the hygiene, transportation, storage, convenience of eating, and the comprehensiveness of food nutrition elements of powdered brewed food have also increased, therefore, the invention of convenient brewed food based on glutinous rice is about to come out.

Therefore, instant rice and a preparation process thereof are in urgent need of research.

### 3. SUMMARY OF THE INVENTION

The object of the invention is to provide instant rice and a preparation process thereof, so as to solve the problems raised in the above-mentioned background art.

In order to solve above technical problem, the invention provides the following technical scheme: instant rice, comprising sticky-free glutinous rice, milk powder, multigrain powder, fruit and vegetable powder, nut powder.

Preferably, the milk powder is prepared milk powder.

Preferably, the multigrain powder is at least one of cereal, jujube powder, red bean powder, potato powder, corn flour, yam powder, sweet potato powder, Job's-tears starch, rice flour, black rice flour, mung bean power and buckwheat flour.

Preferably, the fruit and vegetable powder is at least one of mango powder, purple sweet potato powder, spinach powder, cantaloupe powder, barley seedling powder, strawberry powder, pumpkin powder, tomato powder, celery powder, carrot powder, matcha powder, beetroot powder, black bean powder, lotus root starch.

Preferably, the nut powder is at least one of sesame powder, peanut powder, cashew powder, walnut kernel powder, pumpkin seed powder and pecan powder.

The preparation process of instant rice specifically comprises the following steps:

1) Making sticky-free glutinous rice: washing, soaking and rinsing the glutinous rice, drying it after draining, adding two drops of edible oil, and then continue to bake until it is discolored and ripe, taking it out for standby;

2) Adding auxiliary materials: adding milk powder, multigrain powder, fruit and vegetable powder, nut powder to the sticky-free glutinous rice;

3) Packaging: sealing and packaging the above mixture.

Preferably, in the step 1), the container is shaken throughout the drying process to ensure that any two glutinous rice grains do not stick to each other.

Preferably, in the step 2), the sticky-free glutinous rice, milk powder, multigrain powder, fruit and vegetable powder, nut powder are packaged separately.

Preferably, in the step 3), the packaging method is one of bags, boxes, cans and paper cups.

The invention has the following advantages: simple components, convenient preparation, convenience, feeling full, nutrition, delicious taste and other advantages, breaking the limitation that traditional powdered brewed drinks can only be eaten at home or in snack bars, it can be carried out at home and on travel, and is more suitable for large-scale centralized production, and has a high hygienic index, the industrial standards of its production can be customized to avoid the disadvantages of poor hygienic conditions in snack bars that fail to meet hygienic requirements, it is suitable for single packaging, transportation and long-term storage, and is conducive to the rapid development of the food culture and customs of powder food brewing. It has a wide range of application scenarios, high market commercial value, and benefits the country and the people. It has a good market prospects and promotion of value.

### 4. SPECIFIC EMBODIMENT OF THE INVENTION

The invention will be described below with specific embodiments, but not intended to limit the invention.

The instant rice comprises sticky-free glutinous rice, milk powder, multigrain powder, or fruit and vegetable powder or nut powder or a mixture of multigrain powder, fruit and vegetable powder and nut powder.

The milk powder is prepared milk powder.

The multigrain powder, the fruit and vegetable powder and the nut powder are at least one of cereal, jujube powder, red bean powder, potato powder, corn flour, yam powder, sweet potato powder, Job's-tears starch, rice flour, black rice flour, mung bean power and buckwheat flour, mango powder, purple sweet potato powder, spinach powder, cantaloupe powder, barley seedling powder, strawberry powder, pumpkin powder, tomato powder, celery powder, carrot powder, matcha powder, beetroot powder, black bean powder, sesame powder, lotus root starch, peanut powder, cashew powder, walnut kernel powder, pumpkin seed powder and pecan powder.

The preparation process of instant rice specifically comprises the following steps:

1) Making sticky-free glutinous rice: washing, soaking and rinsing the glutinous rice, drying it after draining, shaking the container throughout the drying process to ensure that any two glutinous rice grains do not stick to each other, adding two drops of edible oil, and then continue to bake until it is discolored and ripe, taking it out for standby;

2) Adding auxiliary materials: adding milk powder, multigrain powder, or fruit and vegetable powder or nut powder or a mixture of multigrain powder, fruit and vegetable powder and nut powder, packing them separately and adding them to the bagged sticky-free glutinous rice;

3) Packaging: sealing and packaging the above mixture.

Specific Embodiment: in the invention, the instant rice is non fried, non puffed, sugar free, preservative free, additive free, seasoning free, instant, chewy and hunger resistant. It is served with milk powder (prepared milk powder), multigrain powder, or fruit and vegetable powder or nut powder or a mixture of multigrain powder, fruit and vegetable powder and nut powder, such as cereal, jujube powder, red bean powder, potato powder, corn flour, yam powder, sweet potato powder, Job's-tears starch, rice flour, black rice flour, mung bean power and buckwheat flour, mango powder, purple sweet potato powder, spinach powder, cantaloupe powder, barley seedling powder, strawberry powder, pumpkin powder, tomato powder, celery powder, carrot powder, matcha powder, beetroot powder, black bean powder, sesame powder, lotus root starch, peanut powder, cashew powder, walnut kernel powder, pumpkin seed powder and pecan powder, it can be brewed directly with boiling water, it can also be heated in the microwave oven with liquid pure milk (yogurt is not acceptable, such as Wangzai sweet reconstituted milk is recommended) (no extra water is required in this case), this makes the product convenient, hunger resistant, nutritious and delicious, and makes the product have a wide range of application scenarios, high market commercial value, a certain contribution to the society, benefiting the country and the people.

The above description is only the preferred embodiment of the invention, but the protection scope of the invention is not limited to this, any person skilled in the art equivalently replaces or changes the technical schemes and the inventive concept of the invention within the technical scope disclosed by the invention shall be included within the protection scope of the invention.

1. The components of instant rice comprise sticky-free glutinous rice, milk powder, multigrain powder, fruit and vegetable powder, nut powder.

2. The instant rice of claim 1, the milk powder is prepared milk powder.

3. The instant rice of claim 1, the multigrain powder is at least one of cereal, jujube powder, red bean powder, potato powder, corn flour, yam powder, sweet potato powder, Job's-tears starch, rice flour, black rice flour, mung bean power and buckwheat flour.

4. The instant rice of claim 1, the fruit and vegetable powder is at least one of mango powder, purple sweet potato powder, spinach powder, cantaloupe powder, barley seedling powder, strawberry powder, pumpkin powder, tomato powder, celery powder, carrot powder, matcha powder, beetroot powder, black bean powder, lotus root starch.

5. The instant rice of claim 1, the nut powder is at least one of sesame powder, peanut powder, cashew powder, walnut kernel powder, pumpkin seed powder and pecan powder.

6. The preparation process of instant rice specifically comprises the following steps:
1) Making sticky-free glutinous rice: washing, soaking and rinsing the glutinous rice, drying it after draining, adding two drops of edible oil, and then continue to bake until it is discolored and ripe, taking it out for standby;
2) Adding auxiliary materials: adding milk powder, multigrain powder, fruit and vegetable powder, nut powder to the sticky-free glutinous rice;
3) Packaging: sealing and packaging the above mixture.

7. The preparation process of instant rice of claim 6, in the step 1), the container is shaken throughout the drying process to ensure that any two glutinous rice grains do not stick to each other.

8. The preparation process of instant rice of claim 6, in the step 2), the sticky-free glutinous rice, milk powder, multigrain powder, fruit and vegetable powder, nut powder are packaged separately.

9. The preparation process of instant rice of claim 6, in the step 3), the packaging method is one of bags, boxes, cans and paper cups.
